(19) United States
(12) Patent Application Publication
(10) Pub. No.: US 2009/0120920 A1
(43) Pub. Date: May 14, 2009

(54) MODULAR FABRICATION UNIT

(76) Inventors: Fred GURNEY, Austin, TX (US); Frank M. Clark, Pittsburgh, PA (US); Rick Uhal, Mckeesport, PA (US); Jay Weinberg, Oakmont, PA (US)

Correspondence Address: REED SMITH LLP, P.O. BOX 488, PITTSBURGH, PA, 15230-0488, US

(21) Appl. No.: 12/212,504

(22) Filed: Sep. 17, 2008

Related U.S. Application Data
(60) Provisional application No. 60/994,153, filed on Sep. 17, 2007.

(51) Int. Cl. B23K 9/00

(52) U.S. Cl. 219/136

(57) ABSTRACT

A completely self contained robotic cell (or modular unit) disposed on air pallets. Also preferably included on the cell also are crane lift points. Thus, these measures allow the cell to be moved within a defined area in a shop, to a different area in a shop, or to other sites such as job sites. Preferably, the cell is also built to dimensions that allow for easy transport by truck to a job site, and are configured as to be stackable with other cells when not in use.

### CROSS-REFERENCE TO RELATED U.S. APPLICATION

This application claims priority under 35 U.S.C. 119(e) from U.S. Provisional Patent Application Ser. No. 60/994,153, filed on Sep. 17, 2007.

### FIELD OF THE INVENTION

The present invention relates generally to workspaces in the form of manufacturing cells, such as robotic welding cells.

### BACKGROUND OF THE INVENTION

Manufacturing cells such as robotic welding cells have existed for several years. They are also often referred to as robotic cells, modular cells, modular units or modular fabrication units (alternative and interchangeable terms that are employed herein). However, they have long presented themselves as highly inflexible and inversatile devices as, given their typical size and heft, are normally provided at a location fixed within a plant. Moving them thus requires tremendous effort, including the use of heavy moving equipment.

Accordingly an ongoing need has been recognized in connection with providing a modular fabrication unit that can offer a user even greater versatility and flexibility than has hitherto been the norm.

### SUMMARY OF THE INVENTION

Broadly contemplated herein, in accordance with a preferred embodiment of the present invention, is a completely self contained robotic cell (or modular unit) disposed on air pallets. Also preferably included on the cell also are crane lift points. Thus, these measures allow the cell to be moved within a defined area in a shop, to a different area in a shop, or to other sites such as job sites. Preferably, the cell is also built to dimensions that allow for easy transport by truck to a job site, and are configured as to be stackable with other cells when not in use.

In summary, there is broadly contemplated herein, in accordance with at least one presently preferred embodiment of the present invention, a modular fabrication cell comprising: a base portion; a wall portion; the wall portion comprising an access portion; and a portability enhancement arrangement which facilitates translational movement of the cell along a substantially planar surface.

### BRIEF DESCRIPTION OF THE DRAWINGS

FIG. 1 shows a modular fabrication cell

FIG. 2A shows, in a top perspective view, essentially the same cell as in FIG. 1, but with additional components.

FIG. 2B shows a bottom perspective view of the cell of FIG. 2A.

FIG. 3 provides a photographic depiction of the underside of a modular cell.

FIG. 4 provides a close-up photographic depiction of a single air pallet.

FIG. 5 provides a photographic depiction of a front of a cell.

FIG. 6 provides a photographic depiction of essentially the same cell as in FIG. 5, but in a left side view.

FIG. 7 provides a photographic depiction of essentially the same cell as in FIG. 5, but at the rear of the cell.

### DESCRIPTION OF THE PREFERRED EMBODIMENTS

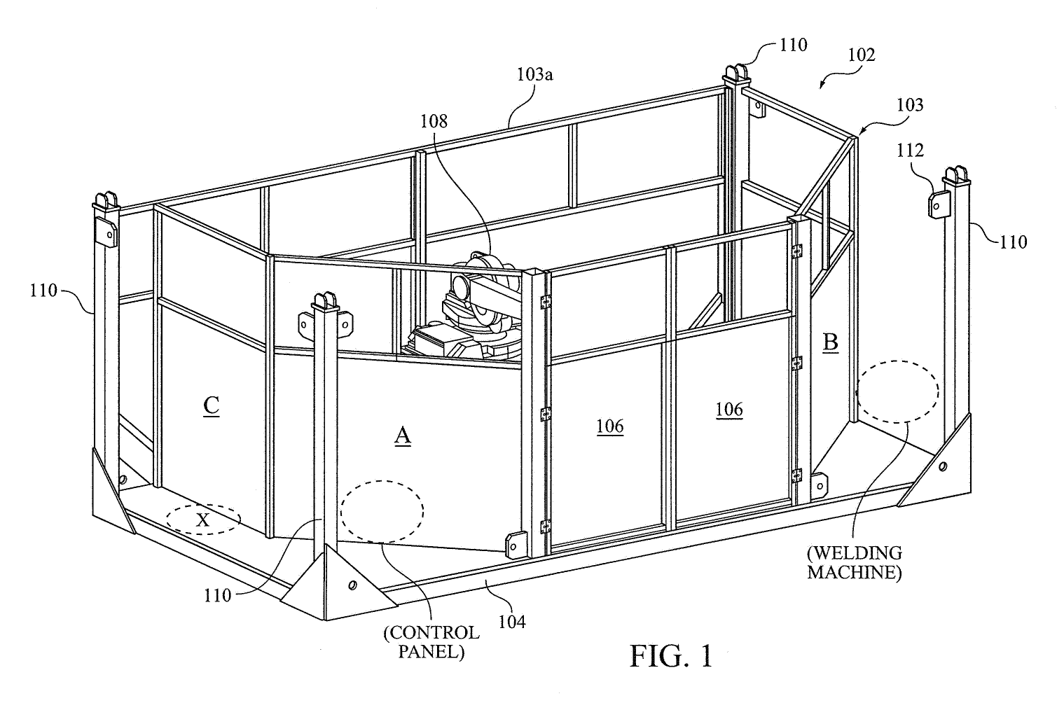

FIG. 1 shows a modular fabrication cell 102, in accordance with a preferred embodiment of the present invention, in perspective view. As shown, walls 103 of the cell are preferably mounted on a rectangular base 104. At the same time, it will be appreciated that, if viewed from the top, walls of the cell in FIG. 1 would present a “semi-octagonal” cross-section, or that type of cross-section that would be akin to bisecting a “STOP” sign from a midpoint of one side to a midpoint of an opposite side.

Preferably, left and right front doors 106 of the cell may be configured to swing to permit access to an interior of the cell (as defined by the walls 103 which combine to form the interior). Diagonal walls A and B respectively extend from the left and right sides of the front panel (constituted by the front doors). Preferably, there will thus be created additional “floor” space atop the base and adjacent these walls A and B (i.e., in two essentially triangular corner regions that lie outside of the cell walls but atop the base) on which components or items may be placed as needed/desired. For instance, as shown, a control panel could be disposed adjacent wall A while a welding machine could be disposed adjacent wall B (prospective general locations of both of these being indicated by dotted elliptical lines).

A robot 108, for its part, is preferably disposed within the cell walls as shown, preferably on its own table, while another work table (not visible in FIG. 1) could be disposed adjacent the robot 108, whereby parts to be welded by the robot could be disposed on the work table. At the same time, the long rear wall 103a of the cell (which may preferably extend between two vertical posts that themselves are disposed at extreme corners of the base) may be configured to be removable to permit even greater access to the cell interior. As such, the rear wall 103a could be slidably displaceable in a vertical direction or could be embodied by one or more swinging doors.

As implied above, four vertical posts 110 are preferably provided at all four extreme corners of the base, and these preferably extend vertically at least to a maximal height of the cell walls. Preferably, several crane lift points (an example of which is indicated at 112 in FIG. 1) may be distributed suitably among the vertical (corner) posts.

As further shown in FIG. 1, the cell may be dimensioned so that there is some extra space, indicated by an “x” within dotted lines, atop the base and adjacent a side wall C, where any of a very wide variety of additional components may be disposed, such as a cabinet (e.g., a tool or equipment cabinet), or an air compression system, or another component suitable to the application at hand.

As further shown in FIG. 1, the vertical posts 110 may have a height that is at least flush with, but preferably greater than, a height (with respect to the floor) of the tops of the cell walls 103. They may also present an interconnectable profile at their upper ends such that, e.g., the upper ends of the posts can mate with lower ends of vertical posts (or with a portion of the underside of a base) of another (similarly dimensioned and configured) cell disposed atop the cell. Accordingly, cells may be stacked for easy storage and/or transport.

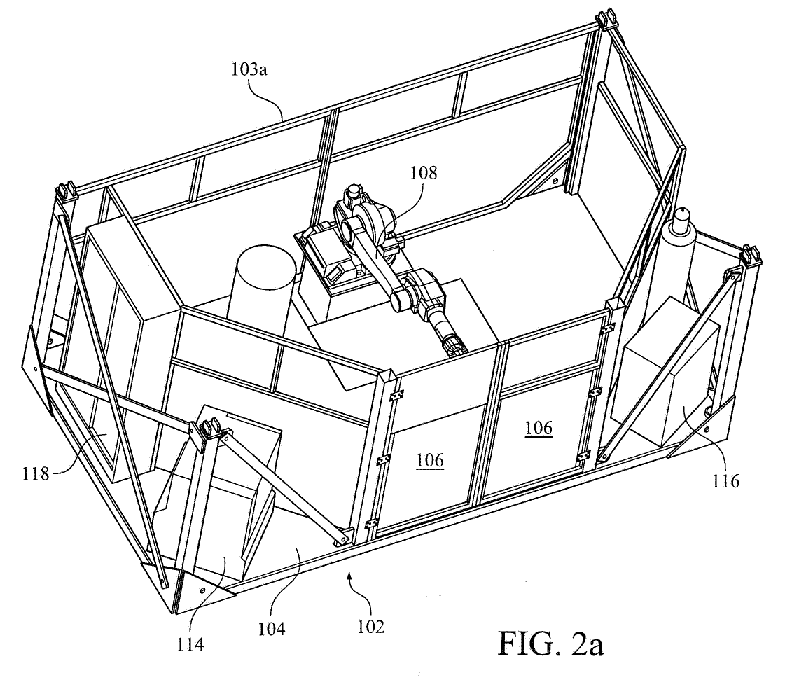

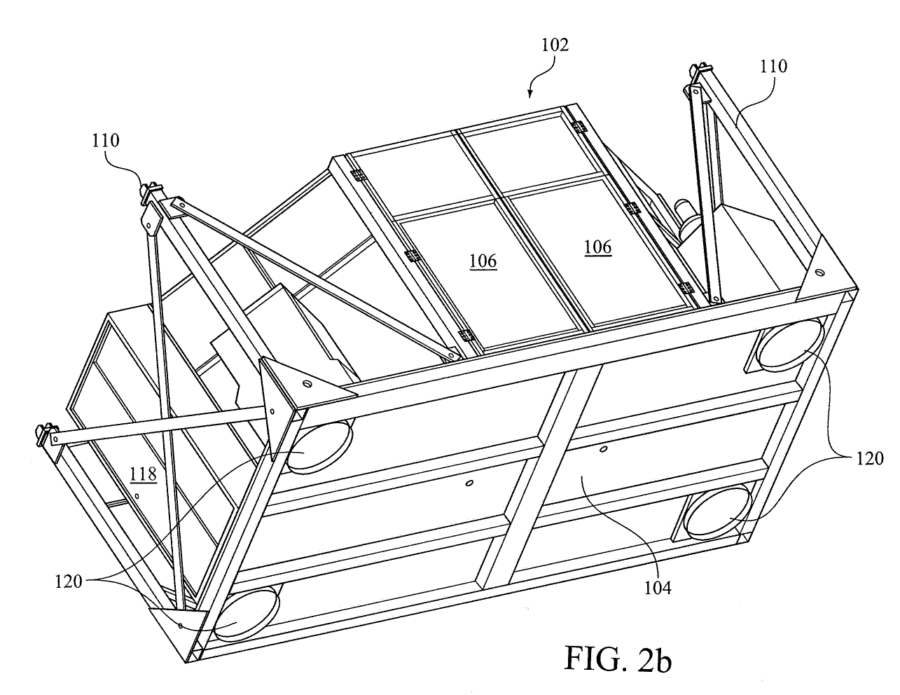

In a top perspective view, FIG. 2A shows essentially the same cell as in FIG. 1, but with additional components. Particularly, there are schematically indicated in FIG. 2A a control panel 114 and welding machine 116 that may be used in conjunction with a welding robot 108, and which may be disposed in locations at corners of the base as discussed above with reference to FIG. 1. Also shown is a cabinet 118 as discussed heretofore, located adjacent a side wall of the cell.

FIG. 2B shows a bottom perspective view of the cell of FIG. 2A, and points out preferred locations of four air pallets 120 at the underside of the cell 102 (and of the base 104), e.g., at extreme corners of the underside of the base 104. Essentially any suitable type of air pallet may be employed that, when activated, would provide a sufficient air cushion beneath the cell as to permit translational movement of the cell with respect to a floor responsive to a moderate translational force applied to the cell (e.g., to a vertical post 110 of the cell 102). Such a moderate translational force could represent a nominal translational force that could be applied, by a single human of average build and strength, by pushing with one or two hands on a portion of the cell (e.g., a vertical post 110 of the cell 102).

In the remaining Figures, any similar or analogous components as found in FIGS. 1-2B are indicated by reference numerals advanced by a multiple of 100.

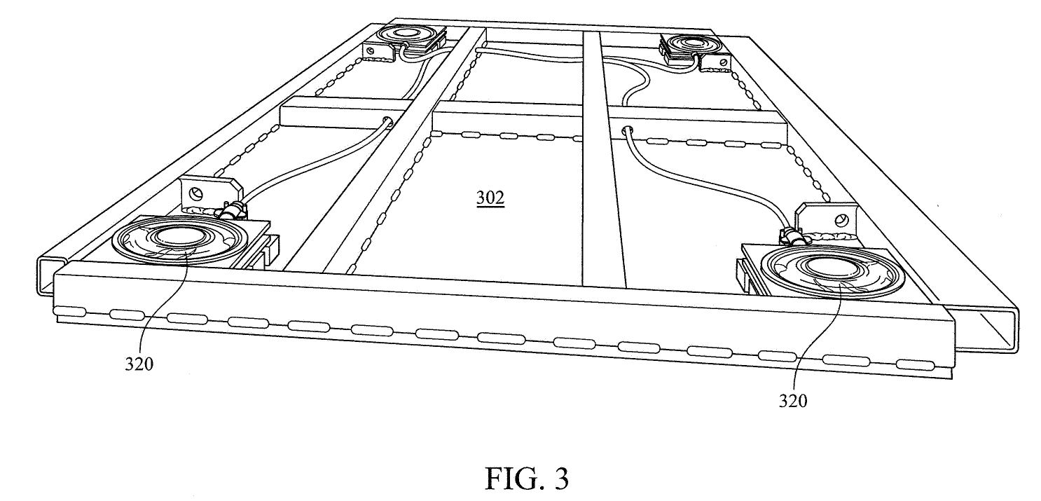

FIG. 3 provides a photographic depiction of the underside of a modular cell 302 in accordance with an embodiment of the present invention, showing in particular two typical air pallets 320 that may be employed.

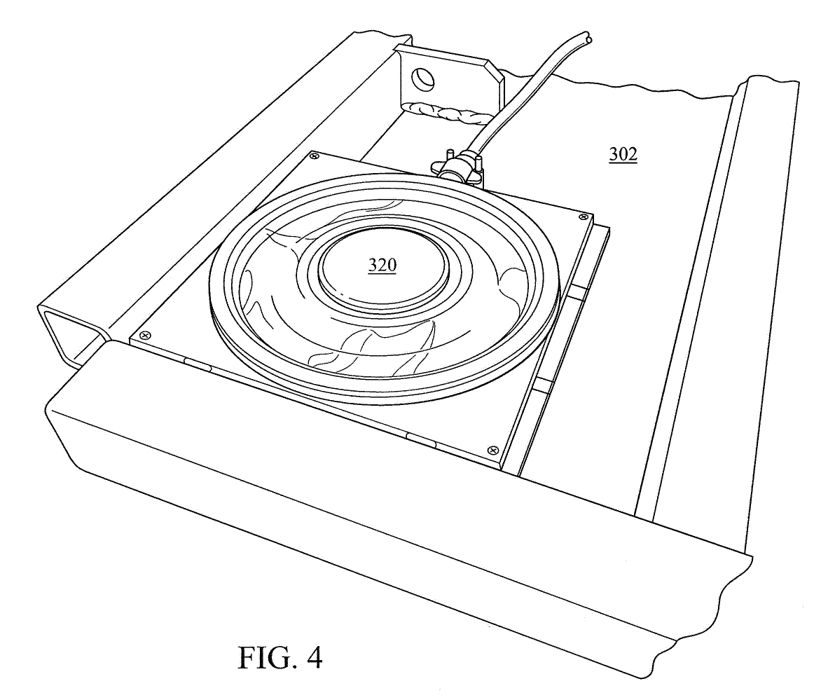

FIG. 4 provides a close-up photographic depiction of a single air pallet 320 that may be employed at the underside of a modular cell 302.

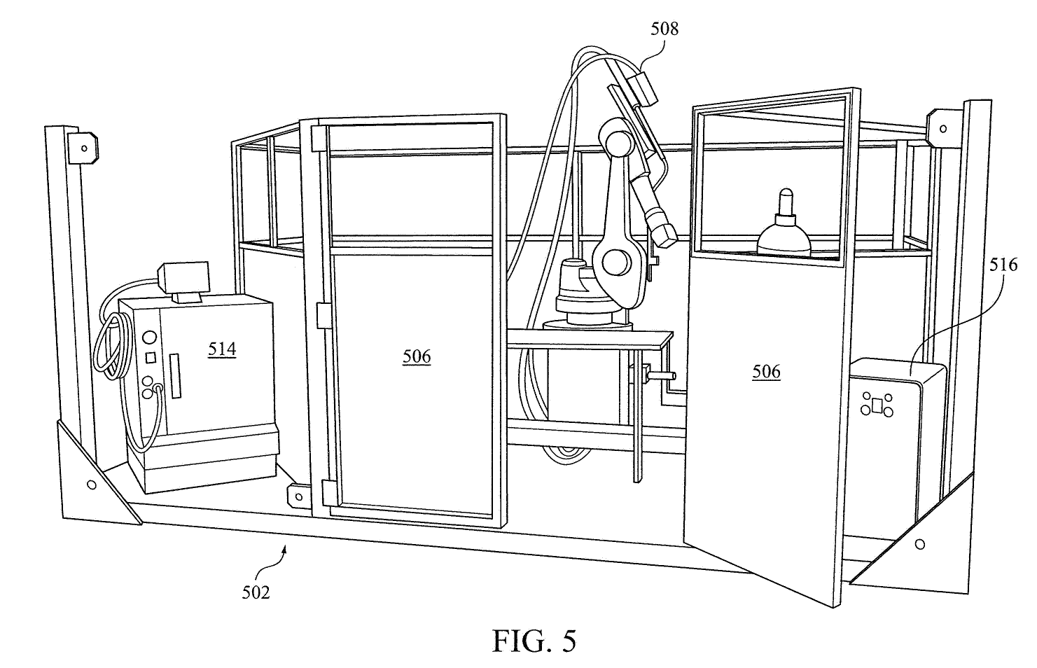

FIG. 5 provides a photographic depiction of a front of a cell 502, with one of two cooperatively swinging front doors 506 shown as being open. Also shown are a control panel, welding machine and robot (514, 516 and 508, respectively).

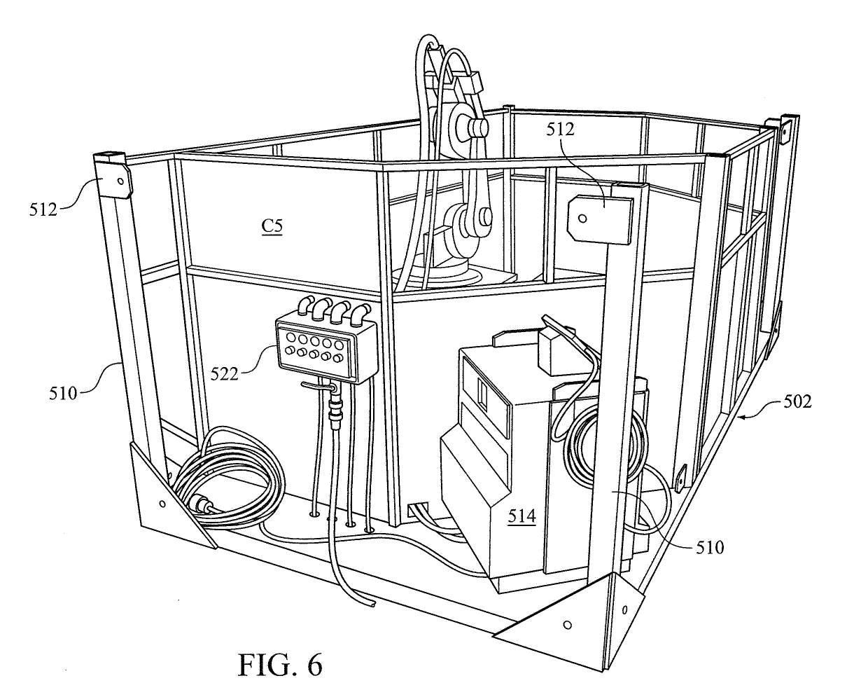

FIG. 6 provides a photographic depiction of essentially the same cell as in FIG. 5, but in a left side view. Further shown is a compressed air unit 522 at wall C5. Also highly visible are two posts 510 and two crane lift points 512.

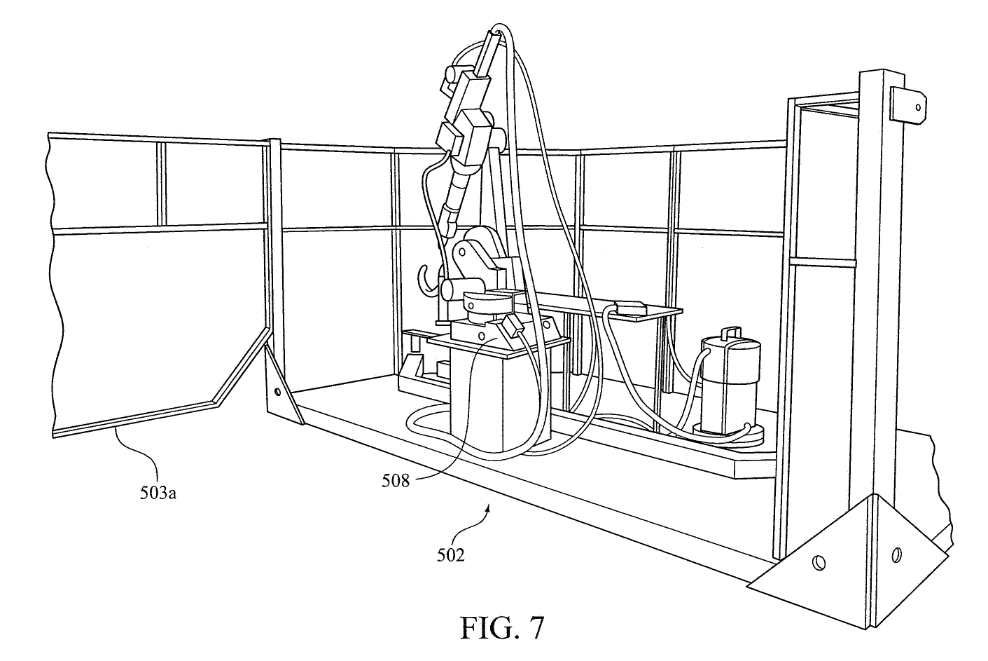

FIG. 7 provides a photographic depiction of essentially the same cell as in FIG. 5, but at the rear of the cell. Here, rear access is shown as being embodied by a large swinging door or gate 503a, providing instant and considerably wide access to the robot 508.

It will be appreciated herein that a cell in accordance with the present invention is a highly agile, highly flexible and portable modular unit that can easily be moved within a plant or to off-site locations including greenfields. It can incorporate any of a very wide variety of conceivable components, such as those discussed hereinabove and, e.g., self-contained electrical power systems, air compression systems and jib cranes. It can be modularly linked to other like or supportive units to establish an agile work manufacturing system. For instance, the rear portions of two such cells may conceivably be disposed adjacent one another such that, when viewed from above, a full octagonal cross-section is formed. Rear access panels or doors, in such an instance, could be removed so as to provide a very large octagonal interior space as defined within the remaining walls of the two cells.

A modular unit or cell in accordance with at least one preferred embodiment of the present invention is preferably mounted on air pallets for ease of positioning within a pre-defined work area. In other words, the translational movement of the cell afforded by activation of the air pallets, as discussed above, can be chosen to be restricted to a defined work area, e.g., by placing tape on the floor about the cell to demarcate the work area. Accordingly, an air pallet encountering such tape will experience a compromised lifting force; workers can thus be admonished ahead of time to always ensure that the cell does not leave the defined work area during translational movement.

The cell can also be readily repositioned via the air pallets or a crane to other locations within the plant (i.e., outside of the pre-defined work area). As needed, it can further be easily moved to other plants or off-site locations, including greenfields or brownfields, and could even be stacked with other cells in transport (in accordance with the stacking feature discussed above with reference to FIG. 1).

As discussed heretofore, a cell can preferably accommodate a robot therewithin, which itself may preferably be mounted at an elevated position to allow workpiece placement on an adjacent table within the cell (see, e.g., FIGS. 5 and 7). Alternatively, rear access door(s) or panel(s) of the cell can be opened (see FIG. 7) to allow the robot to be rotated 180°. This would be of great use, for instance, if the cell has been moved to a desired work area and robotic welding needs (e.g., in view of space considerations) to take place outside of the cell walls.

A cell can preferably be connected to an external power supply, and may be equipped with a jib crane for the placement of parts. The cell can preferably be sized and dimensioned for truck transport to a worksite, and—as discussed further above—is preferably stackable with other cells to help conserve space when cells are not in use.

In brief recapitulation, a modular unit or cell in accordance with a least one preferred embodiment of the present invention is preferably designed for general portability so that it can be transported easily and used in most shop or work site locations with minimum prior preparation, and can be positioned within a shop with or without the use of a crane. The unit is also preferably designed to be modular, to be readily integrable with other related functions and allow it to be set up in off site locations, including greenfields and brownfields. The unit is preferably designed so that when it is not in use it can be stacked with other units to minimize floor space.

To summarize even further the features and advantages associated with embodiments of the present invention, it will be appreciated that there is broadly contemplated herein, in accordance with at least one presently preferred embodiment of the present invention, a modular fabrication cell comprising: a base portion; a wall portion; the wall portion comprising an access portion; and a portability enhancement arrangement which facilitates translational movement of the cell along a substantially planar surface.

The portability enhancement arrangement can facilitate translational movement of the cell responsive to pushing, such as pushing by a human as discussed hereinabove.

The base of the cell has an underside, at which there may preferably be disposed one or more air pallets. The air pallets can be distributed towards an outer periphery of the base, such as at corners of the underside of the base.

The portability enhancement arrangement can further comprise one or more lift points for facilitating lifting of the cell by a lifting object, such as a crane.

Preferably, the wall portion defines a workspace therewithin, and the base portion includes at least one mounting space disposed external to the wall portion with respect to the workspace. While the workspace can be configured for accommodating a welding robot, the at least one mounting space can be configured for accommodating equipment associated with the welding robot, such as (but of course not limited to): a control panel, a welding machine, and a cabinet.

Two such mounting spaces can be denied external to wall segments oriented along a non-right angle with respect to sides of the base portion.

Generally, the wall portion may trace a generally semi-polygonal shape such as a generally semi-octagonal shape. The access portion may be embodied by a door arrangement for permitting human entry into an interior of the cell and further by a gateway arrangement for permitting equipment installation into an interior of the cell, the gateway arrangement being larger than the door arrangement. Preferably, the gateway arrangement may be removable to permit integration of the workspace with a workspace of another cell.

Preferably, there are provided elements promoting stacking of the cell with respect to another cell, and these elements may be embodied by post portions each extending to a height at least high as the wall portion.

Without further analysis, the foregoing will so fully reveal the gist of the present invention and its embodiments that others can, by applying current knowledge, readily adapt it for various applications without omitting features that, from the standpoint of prior art, fairly constitute characteristics of the generic or specific aspects of the present invention and its embodiments.

If not otherwise stated herein, it may be assumed that all components and/or processes described heretofore may, if appropriate, be considered to be interchangeable with similar components and/or processes disclosed elsewhere in the specification, unless an express indication is made to the contrary.

If not otherwise stated herein, any and all patents, patent publications, articles and other printed publications discussed or mentioned herein are hereby incorporated by reference as if set forth in their entirety herein.

It should be appreciated that the apparatus and method of the present invention may be configured and conducted as appropriate for any context at hand. The embodiments described above are to be considered in all respects only as illustrative and not restrictive.

What is claimed is:

1. A modular fabrication cell comprising:
a base portion;
a wall portion;
said wall portion comprising an access portion; and
a portability enhancement arrangement which facilitates translational movement of said cell along a substantially planar surface.

2. The cell according to claim 1, wherein said portability enhancement arrangement facilitates translational movement of said cell responsive to pushing.

3. The cell according to claim 2, wherein:
said base comprises an underside; and
said portability enhancement arrangement comprises at least one air pallet disposed at said underside of said base.

4. The cell according to claim 3, wherein said at least one air pallet comprises a plurality of air pallets.

5. The cell according to claim 4, wherein said plurality of air pallets are distributed towards an outer periphery of said base.

6. The cell according to claim 5, wherein said plurality of air pallets are distributed at corners of said underside of said base.

7. The cell according to claim 1, wherein said portability enhancement arrangement further comprises at least one lift point for facilitating lifting of said cell by a lifting object.

8. The cell according to claim 7, wherein said at least one lift point facilitates lifting by a crane.

9. The cell according to claim 7, wherein said at least one lift point comprises a plurality of lift points.

10. The cell according to claim 1, wherein:
said wall portion defines a workspace therewithin; and
said base portion comprises at least one mounting space disposed external to said wall portion with respect to said workspace.

11. The cell according to claim 10, wherein said workspace is configured for accommodating a welding robot.

12. The cell according to claim 11, wherein said at least one mounting space is configured for accommodating equipment associated with said welding robot.

13. The cell according to claim 10, wherein said at least one mounting space comprises two mounting spaces.

14. The cell according to claim 13, wherein:
said wall portion comprises wall segments oriented along a non-right angle with respect to sides of said base portion;
said mounting spaces being defined external to said wall segments with respect to said workspace.

15. The cell according to claim 14, wherein said wall portion traces a generally semi-polygonal shape.

16. The cell according to claim 15, wherein said wall portion races a generally semi-octagonal shape.

17. The cell according to claim 1, wherein said access portion comprises a door arrangement for permitting human entry into an interior of said cell.

18. The cell according to claim 17, wherein said access portion further comprises a gateway arrangement for permitting equipment installation into an interior of said cell.

19. The cell according to claim 18, wherein said gateway arrangement is larger than said door arrangement.

20. The cell according to claim 18, wherein said gateway arrangement is displaceable to permit integration of said workspace with a workspace of another cell.

21. The cell according to claim 1, further comprising elements promoting stacking of said cell with respect to another cell.

22. The cell according to claim 21, wherein said elements promoting stacking comprising post portions each extending to a height at least high as said wall portion.
